(19) United States
(12) Patent Application Publication
(10) Pub. No.: US 2015/0017410 A1
(43) Pub. Date: Jan. 15, 2015

(54) STATOR WINDING ASSEMBLY

(71) Applicant: General Electric Company, Schenectady, NY (US)

(72) Inventors: James Jun Xu, Niskayuna, NY (US); Jeffrey David Sheaffer, Glenville, NY (US)

(21) Appl. No.: 13/938,550

(22) Filed: Jul. 10, 2013

(51) Int. Cl. H02K 3/30

(52) U.S. Cl. CPC H02K 3/30
USPC 428/220; 525/402; 523/427; 428/413

(57) ABSTRACT

A resin binder for use in formaldehyde emission-free stator insulation. The resin binder includes an epoxy, a catalyst, and a polymer material. The polymer material is hydroxyl-terminated. The resin binder is used in mica tape for groundwall insulation for stator windings.

### FIELD OF THE INVENTION

The invention relates generally to stator winding assembly of an electric machine, and more particularly to resin compositions free of formaldehyde emission that may be applied to a stator winding assembly of an electric machine.

### BACKGROUND OF THE INVENTION

In today's manufacturing environment, there has been an increasing trend of environmental awareness. For instance, due to recent environmental regulatory law, lead paint and asbestos containing buildings have been phased out. Further, formaldehyde has been a focus of more recent trends in legal restrictions. Current restrictions on formaldehyde and formaldehyde emissions vary by area, however typical restrictions are in the range of 0.5 ppm to 4.5 ppm in some European countries and the United States.

These restrictions can pose a challenge for some current electric turbo generators. In some current generators, mica-based ground wall insulation may be utilized for insulation of some parts of the generator. However, mica-based resin, and other currently utilized insulation systems, often contains stand-alone phenolic/novolac resin component. This un-epoxidized phenolic resin component, made from the reaction of phenol and its derivatives with formaldehyde, typically contains approximately 0.001%-0.01% wt. (100 ppm to 1,000 ppm) of formaldehyde residue, which equates to approximately 0.00008%-0.0008% residue in the resin system used in generator stators or large motors, or 0.8 ppm-8 ppm of formaldehyde within the system. While this is more than some current restrictions, it could be assumed that some level, or potentially all, of the formaldehyde is depleted during the high temperature vacuum and curing cycles, as well as stator windings baking cycles. Nevertheless, thermal and electrical aging of insulation systems are known to occur during generator operation. Formaldehyde volatile emission may be produced due to the degradation of those CH₂ linkages formed from those compounds made using formaldehyde as a component. Stator windings and stator cores are the potential main source of the emission. The produced volatiles, if any, are contained within generators during the operation if the machines are cooled with hydrogen. For hydrogen-cooled generators, the procedure to tackle formaldehyde emission, and other volatiles produced during the operation, if there could be any, are typically to discharge them safely out of roof stacks of the building before the opening of the generators. The procedure often coincides with hydrogen discharging steps. A similar discharge of the potential volatiles is often used for air-cooled generators. Formaldehyde volatile emission of hydro generators often pose a higher environmental safety and health challenge to workers than other electric machines thanks to their un-sealed winding constructions. Due to the growing trend of formaldehyde restrictions and the fact that all types of current generators may contain components made using formaldehyde as an ingredient, the conventional method of discharging potential formaldehyde emission out of the building demands an innovative thinking for its improvement.

### BRIEF DESCRIPTION OF THE INVENTION

Embodiments of the invention disclosed herein may include a resin binder for use in formaldehyde emission-free stator insulation, the resin binder comprising: an epoxy; a catalyst; and a polymer material, wherein the polymer material is hydroxyl-terminated.

Embodiments of the invention may also include a method of making a resin binder for use in formaldehyde emission-free stator insulation, the method comprising: mixing an epoxy; dissolving a polymer material into the epoxy, wherein the polymer material is hydroxyl-terminated; and adding a catalyst.

Embodiments of the invention may also include an insulation tape for a stator ground wall, the insulation tape comprising: a mica tape; and at least approximately 25% weight or less than 12% weight of a resin binder incorporated into the mica tape.

Embodiments of the invention may also include some motors where a wrapper of mica insulation is used on the stator slot area.

Embodiments of the invention do not exclude construction of the coating based on the spirit of the invention to coat the stator laminates.

### BRIEF DESCRIPTION OF THE DRAWING

These and other features of the invention will be more readily understood from the following detailed description of the various aspects of the invention taken in conjunction with the accompanying drawings that depict various aspects of the invention.

FIG. 1 shows an illustrative polymer material according to one embodiment of the invention.

FIG. 2 shows a flow diagram of a method according to one embodiment of the invention.

FIG. 3 shows an illustrative insulation tape according to some embodiments of the invention.

FIG. 4a shows an illustrative stator coil wrapped in insulation tape according to some embodiments of the invention.

FIG. 4b shows a cross section view of a stator bar.

FIG. 5 shows an illustrative stator core containing stator coil wrapped in insulation tape according to some embodiments of the invention.

It is noted that the drawings may not be to scale. The drawings are intended to depict only typical aspects of the invention, and therefore should not be considered as limiting the scope of the invention. In the drawings, like numbering represents like elements between the drawings. The detailed description explains embodiments of the invention, together with advantages and features, by way of example with reference to the drawings.

### DETAILED DESCRIPTION OF THE INVENTION

Disclosed herein is a resin binder for use in a stator insulation structure. The inventors have discovered that a resin binder can be formulated that may be formaldehyde free and create a stator insulation material that is formaldehyde emission-free. According to one embodiment, the disclosed resin binder may include at least one epoxy material. The epoxy material may include any now known or later developed epoxy or epoxy resins. These epoxies may include, for example, DEN 438 epoxy and/or DEN 439 epoxy, which are trademarks of The Dow Chemical Company and are available commercially, and Epon 828 epoxy and/or EPON 826 epoxy, which are Momentive Specialty Chemicals trademarks that are available commercially. Further, the resin binder may also include a catalyst in the resin binder. The catalyst can allow the epoxy to set or harden at a desired curing temperature. Many catalysts are known in the art, however as a non-limiting example, the catalyst may include aluminum acetylacetonate, available from most chemical suppliers.

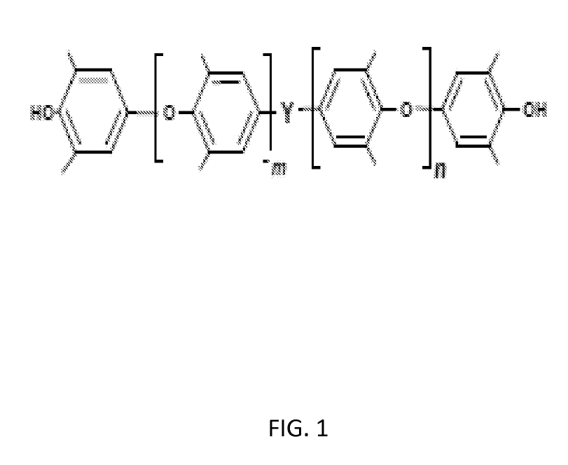

The resin binder may also include a polymer material. The polymer material, according to some embodiments, may include a polymer, a pre-polymer, an oligomer, a low molecular weight compound, or some combination therein, which is hydroxyl-terminated. Some effective examples of hydroxyl-terminated polymers include polyphenylene ether (PPE) polymers and copolymers, Noryl SA90, nonylphenol, Bisphenol-A, Bisphenol-A's dimer, trimer, and tetramer derivatives, and pyrocatechol or 1,2-dihydroxybenzene (catechol), all of which are available from chemical suppliers and epoxy vendors. Turning to FIG. 1, one advantage of the hydroxyl-terminated polymers is the unique oxygen linkage as shown in the hydroxyl-capped PPE telechelic pre-polymer. The illustrated PPE polymer is Noryl SA90 which is a SABIC trademark that is available commercially. In FIG. 1, the Y group may consist of —C(CH₃)₂—, —C(F₃)₂—, or —O— groups. The values of m and n may be equal or not equal. In one embodiment, m+n may equal approximately 10 to 14.

In any case, the polymer material used, including that illustrated in FIG. 1, may include oxygen linkages between components. This can allow for a more flexible and high impact resistance crosslinking between the polymers. In contrast, previous attempts have used a phenolic resin, which instead includes a methylene linkage resulting from the use of formaldehyde as an ingredient. The crosslinking of the current resin binder is more consistently structured, and thus also may maintain a high heat resistance in addition to the advantages listed above. For instance, the heat resistance with a hydroxyl-terminated polymer may be approximately 150° C. as measured by the glass transition temperature (T_{g}), as compared to less than about 70° C. for a phenolic resin, such as the phenolic-novolac resin previously utilized. Further, the phenolic resin contains formaldehyde residue, which can be difficult to be completely removed, although these initial residues may eventually be at least partially removed during some of the heat cycles utilized before winding or coating onto components. The hydroxyl-terminated PPE, when used in combination with other hydroxyl terminated pre-polymers, oligomers, and low molecular weight compounds, has onset curing temperatures that may be better for curing and that can be further tuned to fit in different curing profiles used in manufacturing processes such as an autoclave. However, these processes do not exclude a vacuum pressure impregnation process where curing time and temperature profile can be a challenge to change. In addition, heat resistant characteristics of the resin binder, as measured by the glass transition temperature of cured resins, can be modified for designed heat resistance.

The resin binder may further include a solvent or other above-disclosed liquid low molecular weight hydroxyl-terminated or hydroxyl-containing compounds in order to (1) reduce the viscosity of the resin or resin component for convenience of a resin-making process, or (2) to tailor the curing kinetics, mainly the onset curing temperature to any desired temperature range to fit in various curing profiles. In some embodiments, the solvent may include methyl ethyl ketone (MEK), butanone, and xylene, as some non-limiting examples. In some embodiments, the solvent may contain the polymer material dissolved in a solution.

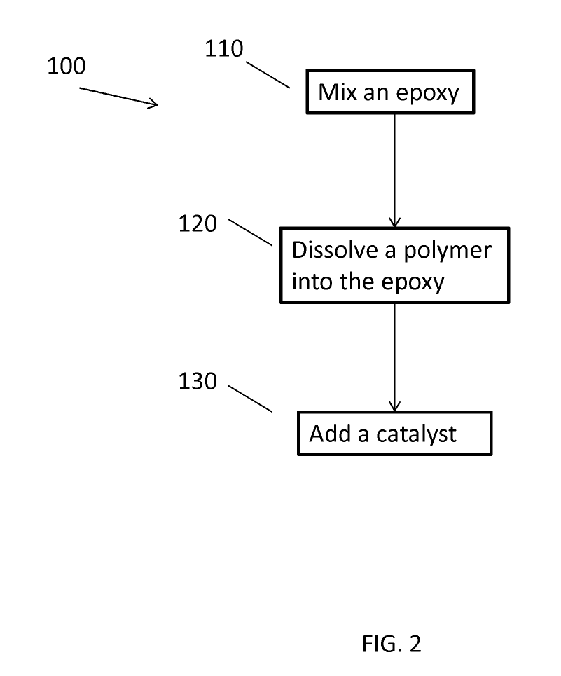

Turning to FIG. 2, a method of making the resin binder is disclosed. In one embodiment, the method 100 includes step 110 of mixing an epoxy. In some embodiments, more than one epoxy may be used for performance enhancement and these epoxies would be mixed together at step 110. The epoxies may include the above disclosed DEN 439 or DEN438 epoxy and Epon 828 or Epon 826 epoxy. The mixing of step 110 may be done at a temperature between approximately 70° C. and approximately 100° C. The temperature of the mixing step may vary depending upon the specific epoxy used.

At step 120, a polymer material, which may include any of the above disclosed polymer materials, may be dissolved into the epoxy that was mixed at step 110 at a temperature between 100° C. and approximately 130° C. This may, in some embodiments, be done shortly after or during the mixing of the epoxy in step 110. In an alternative embodiment, this may be done in the presence of the solvent and/or liquid low molecular weight hydroxyl-terminated or hydroxyl-containing compounds disclosed above to reduce the viscosity. In some cases, the solvent and the polymer material are combined at a ratio of approximately 1:1 prior to dissolving into the epoxy. In some cases, when the liquid nonylphenol is present, a smaller amount of solvent may be used. In some other cases, when solid Bisphenol-A or catechol is present, the ratio of solvent to hydroxyl-terminated polymer may be increased up to 60 to 40. 100% liquid low molecular weight hydroxyl-containing compounds are not designed or desired to replace phenolic resin component as (1) the resultant mica tape made may be “sticky” when taping onto Roebelled bars; or (2) they may be vacuumed out of the wound stator bar during vacuum cycle thus losing the accelerating factor in the curing kinetics. The liquid low molecular weight hydroxyl-containing compounds may be always applied in the presence of the hydroxyl-terminated/capped polymer material for tailoring cure kinetics or adjusting the resin viscosity. The un-dissolved polymer material may affect the epoxy curing properties of the resin binder. For instance, the resin binder may not cure properly or have the same heat resistance if un-dissolved polymer is present. The dissolving of step 120 may be done at a temperature between approximately 50° C. and approximately 70° C. The dissolution of phenolic resin into a solvent requires no or slight heat overnight.

At step 130, the catalyst may be added to the epoxy and polymer material mixture. The catalyst may be added into one of the epoxies, for instance, to Epon 828 in desired ratios to make a homogeneous solution in bulk for multiple uses at the temperature of approximately 100° C. In one embodiment, the catalyst-Epon solution with the calculated ratio and amount is added into a viscous solution of epoxies and hydroxyl-terminated material in a final step at a temperature between approximately 70° C. and approximately 130° C. In one embodiment, the addition at step 130 may be done at approximately 100° C. It should be understood that each of the materials disclosed in the method steps may comprise any of the materials described above in reference to the resin binder.

While step 130 step of making the resin binder is suitable for the application of an autoclave process for making stator components, it is known to those skilled in the art that, at step 130, the catalyst or accelerator can be withheld, so as not to add a catalyst into the bulk resin. For instance, in a vacuum pressure impregnation process, the catalyst or accelerator can be added onto the mica tape, which may contain a minimal amount of resin in order to bind the mica paper together. The bulk resin stored in a tank can be introduced into the slots of stators for curing at certain high temperature when the resin flow is in contact with catalyst-rich mica tape wound on the stator winding coils of a large motor or generator. The storage life of the bulk resin binder is prolonged in the tank.

In one embodiment, the formaldehyde containing phenolic resin has been completely replaced with a hydroxyl-terminated polymer material or in combination with a hydroxyl-terminated organic compound. The concentrations of each component may be varied to achieve the final resin binder that fits varying cure profiles and processes.

In other embodiment, phenolic resin is replaced with a combination of hydroxyl-terminated polymeric material or resin or oligomer and organic compounds, such as, but not limited to, catechol and its derivative (for instance, dihydroxy-α-methylstilbene), nonylphenol, XIAMETER PMX-0156, and Tris(2-hydroxyethyl)isocyanurate

In yet another embodiment, diorganopolysiloxane prepolymer may be used for replacement of the phenolic resin component frequently used for generator insulation systems. They are obtainable from Dow Corning. XIAMETER PMX-0156 is one of such examples. Diorganopolysiloxane is a fluid or gum having a viscosity of at least 10 Pa·s at 25° C., which is terminated with silanol (i.e., —SiOH) groups. The silicon-bonded organic groups of the component can be independently selected from hydrocarbon groups. These may be specifically exemplified by alkyl groups having 1 to 20 carbon atoms, such as methyl, ethyl, propyl, butyl, pentyl and hexyl; cycloalkyl groups, such as cyclohexyl and cycloheptyl; alkenyl groups having 2 to 20 carbon atoms, such as vinyl, allyl and hexenyl; aryl groups having 6 to 12 carbon atoms, such as phenyl, tolyl and xylyl; aralkyl groups having 7 to 20 carbon atoms, such as benzyl and phenethyl; and halogenated alkyl groups having 1 to 20 carbon atoms. These groups are selected such that the diorganopolysiloxane has a glass transition temperature (or melt point) below room temperature and forms an elastomer when cured. Methyl may make up at least 85, or even at least 90, mole percent of the silicon-bonded organic groups. The hydroxyl-terminated polymer material may also include hydroxyl-terminated polyester, and hydroxyl-terminated polyisobutylene, as taught by U.S. Pat. No. 4,429,099.

Table 1 illustrates a comparison between one example of the polymer material of the present invention, compared to the phenolic and novolac resins of previous materials.

TABLE 1
Molecular characteristic of hydroxyl-terminated polymer and organic compounds

| | | | | | THEIC | | |
|---|---|---|---|---|---|---|---|
| | | | | | Tris(2-hydroxy- | | |
| | Phenolic | Novolac | Noryl ® | XIAMETER | ethyl)iso- | Catechol | Nonylphenol |
| Resin | resin | resin | SA90 | PMX-0156 | cyanurate | C₆H₄(OH)₂ | C₁₅H₂₃OH |
| Estimated | 120-480 | 120-240 | 800 | 400 | 87 | 65 | 220 |
| hydroxyl | | | | | | | |
| equivalent | | | | | | | |
| weight | | | | | | | |
| (g/mol) | | | | | | | |
| Number of | 250-1,000 | 250-900 | 1700 | 800-10,000 | 261 | 110 | 220 |
| average | | | | | | | |
| molecular | | | | | | | |
| weight | | | | | | | |
| Weight | 500-3,000 | 500-7,000 | 4200 | n.a. | 261 | 110 | 220 |
| average | | | | | | | |
| molecular | | | | | | | |
| weight | | | | | | | |
| Glass | 35-70 | 45-75 | 135-150 | n.a. | 80 | n.a. | n.a. |
| transition | | | | | | | |
| temperature | | | | | | | |
| (° C.) | | | | | | | |
| Typical | 100-1,000 | 100-1,000 | 0 | 0 | 0 | 0 | 0 |
| formaldehyde | | | | | | | |
| residue | | | | | | | |
| (ppm) | | | | | | | |

As is clear from Table 1, the polymer material according to current embodiments can have a much higher hydroxyl equivalent weight relative to previous resins. Further, when there is a need to match the hydroxyl equivalent weight of the new component to that of phenolic resin if fitting existing cure profiles or processes is so desired, one may achieve this by mixing the polymer material with other low hydroxyl equivalent weight material such as catechol or Bisphenol A, or nonylphenol, etc. For instance, a 1:1 ratio of catechol to the polymer material in MEK or xylene results in 432 hydroxyl equivalent weight which is in the range of phenolic resin. In some embodiments, more polymer material may still be used despite this, as it can enhance the mechanical and thermal properties. Additional polymer material may increase the heat resistance, increasing the thermal properties, and decrease the loss of material under heating, as well as create a stronger resin, increasing the mechanical properties. These enhance mechanical and thermal properties can be due to more crosslinking between polymer molecules by increasing the polymer material. It can also be seen from Table 1 that the glass transition temperature, and thus the heat resistance, is higher in the polymer material. In practice, the polymer material is added to its dissolvable quantity in the designed ratio of DEN epoxy and EPON epoxy.

When applied as a resin binder for resin-rich mica tape for stator winding, the autoclave cure method of the composition in either resin form or tape form is achieved by heating to approximately 80° C.-140° C. at the rate between approximately 0.14° C./min to approximately 0.24° C./minute for prolonged period of time, such as about 8-10 hours, during the vacuum cycle. The temperature is then raised quickly to approximately 160° C. to approximately 175° C. for approximately 10 hours to allow the tape binder to flow and its cure to take place. The resultant cured resin binder or tape has a hardness of approximately 80 to approximately 94, as measured by Shore D harness in accordance with ASTM D2244. The glass transition temperature (T_{g}) of the resultant cued resin binder or tape, a measure of degree of resin cure and its heat resistance, may be in the range of approximately 135° C. to approximately 165° C.

T_{g} of the resin binder or tape is further increased to approximately 180° C. when higher temperatures are practiced in both vacuum and cure cycles. The ultimate T_{g} of the composition can reach approximately 190° C. in curing tests.

It is known that dielectric properties such as a dissipation factor (D_{f}) of stator winding is associated with inner local Joule heating in the insulation winding matrix. The higher D_{f} results in the higher local heating and the higher propensity of local degradation and micro-defect formation, thus the higher the local electrical stress concentration. D_{f} determined at high temperatures, such as 100° C. or 155° C. (hot D_{f}) is a measure of such a dielectric property. When T, is below a certain value, for instance, below 110° C.-120° C., the lower T, is correlated inversely with high hot D_{f}. Therefore, T_{g} may preferably be kept above 110° C.-120° C. from dielectric standpoint alone. Nevertheless, mechanical and thermal properties demand for relatively high T_{g}, for instance, it is preferred that T, is greater than 130° C.

A few examples are given below to illustrate the invention, showing that a stator winding ground wall insulation resin binder may be made without formaldehyde residue carrying from phenolic resin and that is thermally stable.

### Example 1

Control: 98.5 grams of DEN 439, 46.1 grams of Epon 828 and 36 grams of 50% wt phenolic resin-MEK solution were mixed in a glass container, sealed, power-magnet stirred and heated to 100° C. to 130° C. for 2-4 hours. The homogeneous solution is then cooled to 25° C.-50° C. The solution is then mixed at 100° C.-130° C. for 1-3 hours with 20 grams of Epon 828 solution containing dissolved 0.5 gram of catalyst aluminum acetoacetate. The solution is allowed to cool in a vacuum oven at 25° C.-50° C. overnight. The Epon 828-catalyst solution was made in bulk for multiple uses at 100° C. for 2 hours. The 50% wt phenolic resin and 50% wt MEK or 50% wt phenolic resin and 50% wt xylene solution was made in bulk for multiple uses at approximately room temperature or slightly higher than room temperature overnight. The resultant uncured resin has T_{g} between −6° C. and 6° C., more specifically 3.8° C. determined by DSC (differential scanning calorimetry) in accordance with ASTM E1356. The viscosity simulated at 110° C., a typical vacuum cycle temperature for autoclave cure, is approximately 7991 cps using WLF equation. The onset curing temperature (OCT) measured by DSC of the resultant resin, a measure of cure-triggering temperature, is between 185° C. and 200° C. The OCT is very important and varies with pre-cure time-temperature profile. The prolonged pre-cure cycle reduces OCT, so does a vacuum cycle whose temperature is higher than 110° C. In addition, in practice, the cure is often triggered at the temperature 10-20° C. below the measured OCT. The T_{g} of the resultant cured resin is between 150° C. to 190° C. when the cure temperature may be raised to more than 190° C.

### Example 2

92.5 grams of DEN 439, 40.7 grams of Epon 828, and 120 grams of 50% wt SA90-MEK solution were mixed in a glass container, sealed, power-magnet stirred and heated to 100° C. to 130° C. for 2-4 hours. The homogeneous solution is then cooled to 25° C.-50° C. The solution is then mixed at 70° C.-130° C. for 1-3 hours with 20 grams of Epon 828 solution containing dissolved 1.0 gram of catalyst aluminum acetoacetate. The solution is allowed to cool in a vacuum at 25° C.-50° C. overnight. The Epon 828-catalyst solution was made in bulk for multiple uses at 100° C. for 2 hours. The 50% wt Noryl SA90 and 50% wt MEK or 50% wt Noryl SA90 and 50% wt xylene solution was made in bulk for multiple uses at approximately 50° C.-70° C. for a few hours in a sealed condition. The resultant uncured resin has T_{g}=−16.6° C., determined by DSC in accordance with ASTM E1356. The viscosity simulated at 110° C., a typical vacuum cycle temperature for autoclave cure, is approximately 4160 cps using WLF equation. The onset curing temperature (OCT) measured by DSC of the resultant resin, is approximately 214° C. The OCT varies with pre-cure time-temperature profile. The T_{g} of the resultant cured resin is 159° C.

### Example 3

92.5 grams of DEN 439, 40.7 grams of Epon 828, and 60 grams of 50% wt SA90-MEK solution were mixed in a glass container, sealed, power-magnet stirred and heated to 100° C. to 130° C. for 2-4 hours. The homogeneous solution is then cooled to 25° C.-50° C. The solution is then mixed at 70° C.-130° C. for 1-3 hours with 20 grams of Epon 828 solution containing dissolved 1.0 gram of catalyst aluminum acetoacetate. The solution is allowed to cool in a vacuum at 25° C.-50° C. overnight. The Epon 828-catalyst solution was made in bulk for multiple uses at 100° C. for 2 hours. The resultant uncured resin has T_{g}=−12° C., determined by DSC in accordance with ASTM E1356. The viscosity simulated at 110° C., a typical vacuum cycle temperature for autoclave cure, is approximately 4755 cps using WLF equation. The onset curing temperature (OCT) measured by DSC of the resultant resin, is approximately 230° C. The OCT varies with pre-cure time-temperature profile. The T_{g} of the resultant cured resin is 164° C.

### Example 4

105.1 grams of DEN 439, 14.9 grams of Epon 828, and 120 grams of 50% wt SA90-MEK solution were mixed in a glass container, sealed, power-magnet stirred and heated to 100° C. to 130° C. for 2-4 hours. The homogeneous solution is then cooled to 25° C.-50° C. The solution is then mixed at 70° C.-130° C. for 1-3 hours with 20 grams of Epon 828 solution containing dissolved 0.05 gram of catalyst aluminum acetoacetate. The solution is allowed to cool in a vacuum at 25° C.-50° C. overnight. The Epon 828-catalyst solution was made in bulk for multiple uses at 100° C. for 2 hours. The resultant uncured resin has T_{g}=−6.7° C., determined by DSC in accordance with ASTM E1356. The viscosity simulated at 110° C., a typical vacuum cycle temperature for autoclave cure, is approximately 5599 cps using WLF equation. The onset curing temperature (OCT) measured by DSC of the resultant resin is approximately 250° C. The OCT varies with pre-cure time-temperature profile. The T_{g} of the resultant cured resin is 158° C.

### Example 5

98.5 grams of DEN 439, 46.1 grams of Epon 828, 30 grams of THEIC (tris(2-hydroxyethyl)isocyanurate) and 72 grams of 50% wt SA90-MEK solution were mixed in a glass container, sealed, power-magnet stirred and heated to 100° C. to 130° C. for 2-4 hours. The homogeneous solution is then cooled to 25° C.-50° C. The solution is then mixed at 70° C.-130° C. for 1-3 hours with 20 grams of Epon 828 solution containing dissolved 0.1 gram of catalyst aluminum acetoacetate. The solution is allowed to cool in a vacuum at 25° C.-50° C. overnight. The Epon 828-catalyst solution was made in bulk for multiple uses at 100° C. for 2 hours. The resultant uncured resin has T_{g}=−13° C., determined by DSC in accordance with ASTM E1356. The viscosity simulated at 110° C., a typical vacuum cycle temperature for autoclave cure, is approximately 4603 cps using WLF equation. The onset curing temperature (OCT) measured by DSC of the resultant resin is approximately 250° C. The T_{g} of the resultant cured resin is 150° C.

The thermal capability of groundwall insulation for stator winding is important. The temperature at which the resin loses its 5% weight is 321° C., which is comparable to the control resin whose average thermal stability temperature at 5% wt loss is 322° C. The projected life of control resin and formaldehyde-free composition is compared after an accelerated dynamic life testing using Thermogravimetric Analyzer in reference to ASTM E1461 and E1877. The end of life criterion is not the failure of micaeous groundwall insulation of 100-150 mil (1 mil=25 microns), but the neat resin when losing 5% wt for purpose of comparison of the resin binders. The new resin binder has typical thermal life of 20 years at 140° C., compared with an average thermal life of the control resin binder which is 20 years at approximately 135° C. The slight increase in the projected thermal life of new resin binder may mean that it may be at least the same as that of the control in terms of thermal capability, which is expected.

TABLE 2
Comparison of Thermal Stability of Resin Binders

| | | Temperature indicates \|° C.\| | | |
|---|---|---|---|---|
| | Temperature \|° C.\| at | 5% wt less by ASTM E1877 | | |
| Neat resin | 5% wt lost by fGA | 2.2 years | 20 years | 30 years |
| New resin | 321 | 161.7 | 139.5 | 135.6 |
| control | 322 | 158.0 | 135.2 | 131.3 |

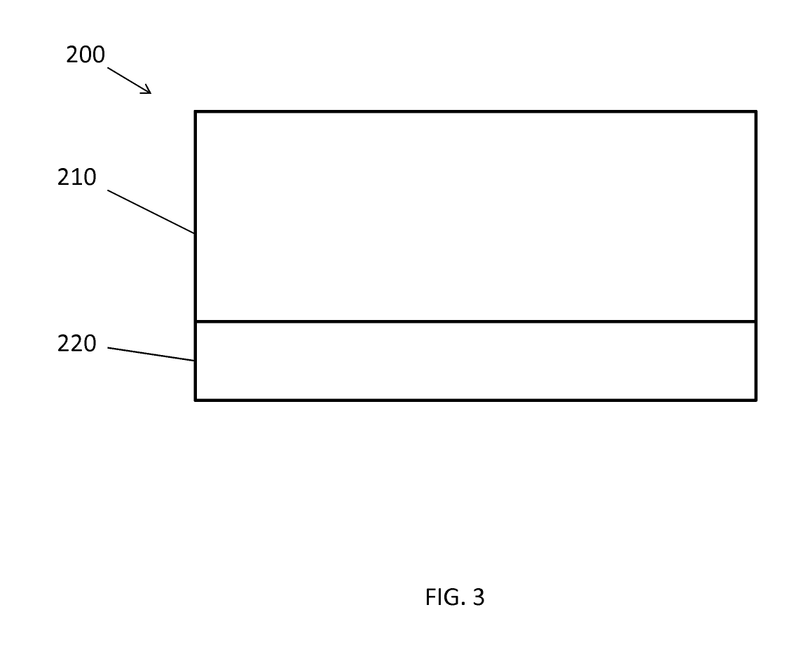

Turning to FIG. 3, in another embodiment, an insulation tape 200 for a stator ground wall is disclosed. The resin binder disclosed above may be used in the in insulation tape 200. For instance, insulation tape 200 may be a mica tape, as one non-limiting example. Insulation tape 200 may include at least approximately 25% weight of the resin binder disclosed above, which has been incorporated into insulation tape 200. In some embodiments, the resin binder may be included at a weight percent between approximately 30% and approximately 36%. The tape made with this resin composition construction is suitable for autoclave curing process.

Still referring to FIG. 3, in another embodiment, the resin binder disclosed above may be used in the insulation tape 200. For instance, insulation tape 200 may be a mica tape, as one non-limiting example. Insulation tape 200 may include approximately no more than 12% weight of the resin binder disclosed above, which has been incorporated into insulation tape 200. In some embodiments, the resin binder may be included at a weight percent between approximately 8% and approximately 12%. The tape made with this resin composition construction is suitable for winding stator coils which are cured using a vacuum pressure impregnation process. In a VPI process, the bulk of such mentioned resin binder is in low viscosity form and without a catalyst or even an accelerator, and may be poured into the slots of stators for curing.

Still referring to FIG. 3, insulation tape 200 may include a mica paper layer 210. In some embodiments, mica paper layer maybe approximately 4 mil (1 mil=˜25 microns) to approximately 7 mil thick. The resin binder may be incorporated into mica paper layer 210 by any now known or later developed impregnation method. Methods of impregnating mica tape are known in the art. In further embodiments, mica paper layer 210 may include other materials, such as a curing agent or an accelerator. Any now known or later developed curing agents and accelerators may be included in mica paper layer 210. Insulation tape 200 may also include a glass backing layer 220 of approximately 2 mil. Different materials which may be used for glass backing layer 220 are known in the art. Glass backing layer 220 may be approximately 2 mil thick. The impregnated mica tape may also be sandwiched between two glass backing layers 220. While the glass backer is preferred, other backing layers may be used such as, but not limited to, Dacron® polyester fiber from DuPont.

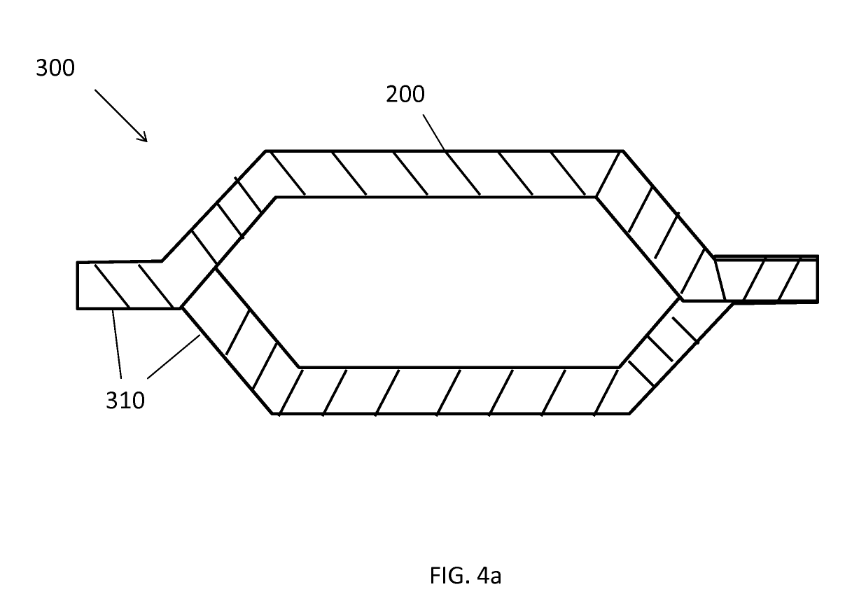

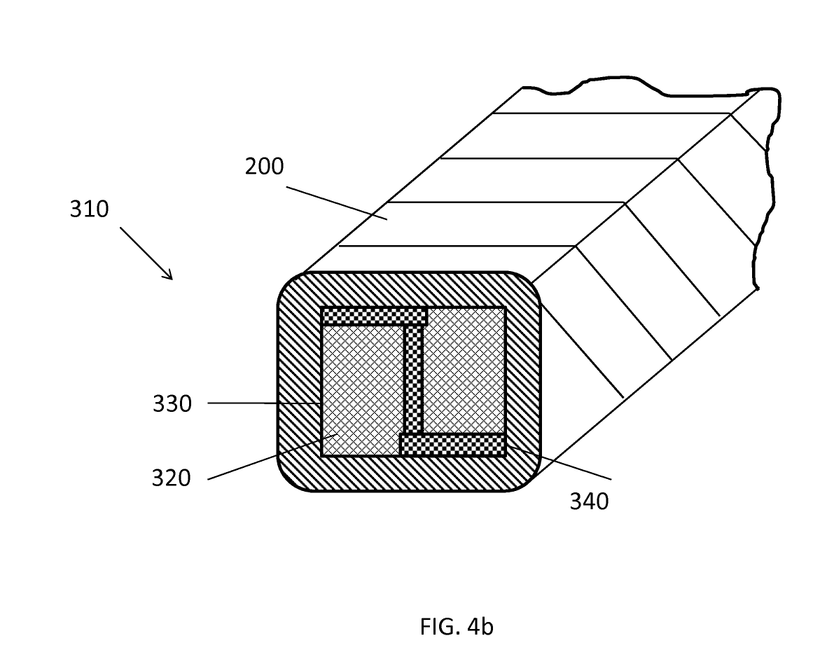

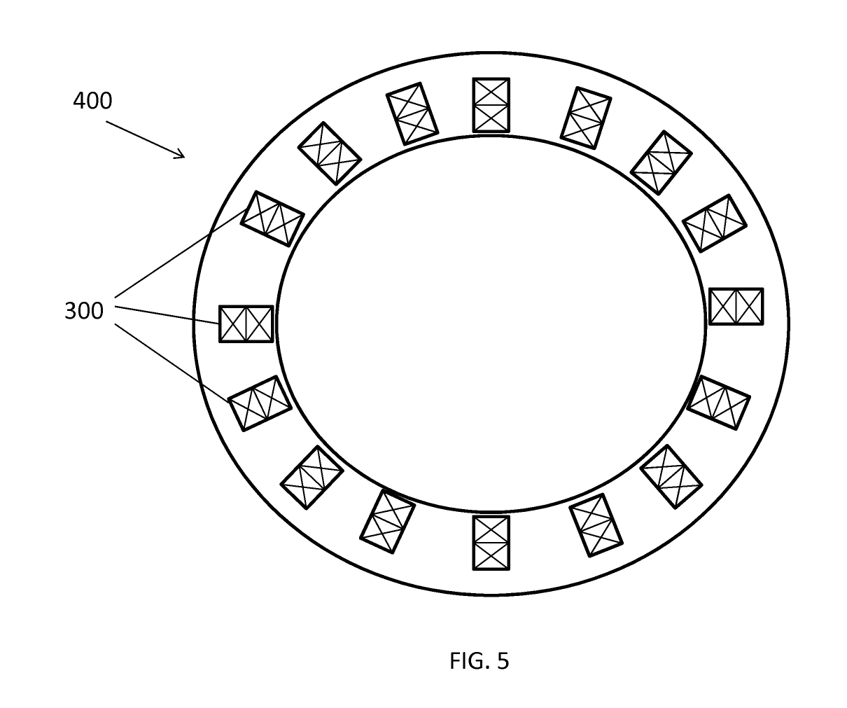

Turning to FIG. 4a, insulation tape 200 may be used as insulation for stator bars 310. As illustrated, stator bars 310, when included as a pair as shown, may comprise a stator coil 300. A plurality of stator coils 300 may be inserted into a stator core 400 (FIG. 5) of a generator, as illustrated in FIG. 5. Returning to FIG. 4, each stator bar 310 may be wound with insulation tape 200. Stator bar 310 may be substantially rectangular at the cross-section, as illustrated in FIG. 4b. Referring to FIG. 4b, stator bar 310 may contain hollowed conductor strands 320 if it is liquid cooled design, with strand insulation 330 therebetween. Stator bar 310 may also include strand separators 340. Stator bar may include insulation tape 200 wrapped around the outside of stator bar 310 as illustrated. Returning to FIG. 4a, any now known or later developed stator bar 310 which may be part of a stator coil 300 for a stator core 400 (FIG. 5) of a generator that may be wrapped in insulation tape 200 are included. It should be understood that stator bars may vary greatly, however the formaldehyde free binder included in insulation tape 200 may be utilized for most. In any case, once stator bar 310 has been wrapped in insulation tape 200, stator bar 310 with insulation tape 200 may be cured. If a solvent was used in the resin binder, some or all of the solvent may be driven off during the procuring vacuum cycle.

The curing process may require modification from known autoclave curing processes. In some embodiments, the stator bar 310 may be held in a vacuum cycle, in some instances in a range of approximately 80° C. to approximately 140° C. This temperature may be held for approximately 8 hours up to approximately 12 hours. In a further embodiment, following the vacuum cycle, stator bar 310 may then undergo a curing cycle. The curing cycle may be done at approximately 160° C. to approximately 175° C. The curing cycle may be held for anywhere from about 12 hours to about 20 hours. In some embodiments, the temperature will be gradually lowered following the curing cycle. This may allow the thermal stress of stator bar 310 with insulation tape 200, now cured, to be lowered or even eliminated. The stored thermal stress in stator bars encourages the potential crack and delamination of the ground wall insulation during the process and services.

In another embodiment, stator bar 310 with resin-poor insulation tape 200 may be cured using a vacuum pressure impregnated (VPI) process. In these embodiments, stator bars 310, stator coils 300, or wound stators may be heated to a low temperature prior to being placed in the VPI tank. The VPI tank may then be sealed and a vacuum applied in order to remove air and any volatiles. While stator bars 310 or stator coils 300, or entire wound stators are still under vacuum, the resin may be introduced from a resin storage tank. After atmosphere pressure is arrived in the tank, the VPI tank may then be pressurized with inert gas to drive the resin into the insulated bars or coils in the tank. Individual bars are generally clamped in a fixture to consolidate the insulation either prior to or after impregnation. After the VPI process is complete the bars or coils or wound stators are generally put into an oven to cure the resin. The thermal relaxation process follows the cure in order to encourage the elimination of potentially stored thermal stress. It is often achieved with a gradually lowering temperature profile.

Referring to autoclave curing, once stator bar 310 has been cured, insulation tape 200 including the resin binder is properly cured and set. Stator bars 310 may be inserted into stator core 400. Now a plethora of stator bars 310 may be paired with a second stator bar 310 to make a stator coil 300 while they are placed in slots of the stator core 400. Without the inclusion of any formaldehyde residue in the stator winding assembly, not only is stator coil 300 free of formaldehyde at the beginning of operation, but there may be no formaldehyde emissions at the generator operating temperatures, including stator core 400, from the stator coils 300. As a result, a stator winding free of formaldehyde emission may be achieved.

In a further embodiment, referring to the above stator coil winding, the stator cores that bars are wound into and then coiled by brazing and connecting together are typically made up by stacking hundreds of thousands of stator punching laminations. Each of the laminations has a thin coating to insulate them from each other to reduce the loss due to an Eddy current. These lamination coatings may potentially be susceptible to release formaldehyde due to degradation during generator operation, especially under abnormally high temperature operation.

While use of the resin binder has been described with regard to insulation around stator bars 310, it should be understood that stator core 400 may also have the resin binder incorporated into the material used to coat the punching laminations of stator core 400. In such an embodiment, rather than including the resin binder in insulation tape 200, stator core 400 may have the resin binder cured to part of the material, insulating the whole stator assembly. As a result, a stator assembly free of formaldehyde emission may be achieved.

Still referring to laminations of stator core 400, formaldehyde-free materials for coating the laminations are not limited to the epoxy-based solution provided above. Any non-formaldehyde-containing coatings that meet thermal, electrical, mechanical, and chemical requirements of laminations specified by OEM are not excluded, such as, but not limited to, filler-containing acrylate coating systems, filler-containing high temperature polyester coating systems, filler-containing polyamideimide coating systems, and any further inorganic particulate material filled coating systems.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A resin binder for use in formaldehyde emission-free stator insulation, the resin binder comprising:
an epoxy or a combination of epoxies with desired performance;
a catalyst; and
a polymer material, wherein the polymer material is hydroxyl-terminated.

2. The resin binder of claim 1, the polymer material further including an organic compound, the organic compound being hydroxyl terminated.

3. The resin binder of claim 1, further comprising:
a solvent, the solvent being chosen from the group consisting of: MEK, butanone, xylene, and a low molecular weight hydroxyl-containing organic compounds in a liquid form.

4. The resin binder of claim 1, wherein the epoxy is chosen from the group consisting of: DEN 439 epoxy, DEN438 epoxy, EPON 828 epoxy, EPON826 epoxy, and some combination thereof.

5. The resin binder of claim 4, wherein a ratio of DEN to EPON epoxies is between 3:2 and 3:1, a ratio of the epoxy to the hydroxyl-terminated polymer material is between 95:5 and 85:15, and a ratio of the epoxy to the catalyst is between 90:0.05 and 90:0.2.

6. The resin binder of claim 1, wherein the polymer material is chosen from the group consisting of: a hydroxyl-capped polymer, a pre-polymer, and an oligomer.

7. The resin binder of claim 6, wherein the polymer material is chosen from the group consisting of: Noryl SA90, nonylphenol, hydroxyl-terminated silicone, catechol, tris (2-hydroxyethyl)isocyanurate), hydroxyl-terminated silicone, Bisphenol-A, and Bisphenol-A's dimer, trimer, and tetramer derivatives.

8. A method of making a resin binder for use in formaldehyde emission-free stator insulation, the method comprising:
mixing an epoxy;
dissolving a polymer material into the epoxy, wherein the polymer material is hydroxyl-terminated;
dissolving the polymer material into a solvent,
adding a catalyst into the epoxy to form a homogeneous solution, and
adding the catalyst-epoxy solution into the mixed epoxy-polymer material solution.

9. The method of claim 8, the polymer material further including an organic compound, the organic compound being hydroxyl terminated or hydroxyl capped.

10. The method of claim 8, wherein the mixing of an epoxy and dissolving the polymer material into the mixed epoxy is done at a temperature between approximately 70° C. and approximately 130° C., or more specifically at approximately 100° C. to approximately 130° C.

11. The method of claim 8, wherein the polymer material is in a solvent, the solvent being chosen from a group consisting of: MEK, butanone, xylene, and a low molecular weight hydroxyl-containing organic compound in a liquid form.

12. The method of claim 11, wherein the solvent and the polymer material are at a ratio of approximately 1:1.

13. The method of claim 12, wherein the dissolving is done at a temperature between approximately 50° C. and approximately 70° C.

14. The method of claim 8, wherein the epoxy is chosen from the group consisting of: DEN 439 epoxy, DEN438 epoxy, EPON 828 epoxy, EPON826 epoxy, and some combination thereof.

15. The method of claim 14, wherein a ratio of DEN to EPON epoxies is between 3:2 and 3:1, a ratio of the epoxy to the hydroxyl-terminated polymer material is between 95:5 and 85:15, and a ratio of the epoxy to the catalyst is between 90:0.05 and 90:0.2.

16. The method of claim 8, wherein the adding is done at a temperature between approximately 70° C. and approximately 130° C., or more specifically at approximately 100° C.

17. The method of claim 8, wherein the polymer material is chosen from the group consisting of: a polymer, a pre-polymer, and an oligomer.

18. The method of claim 17, wherein the polymer material is chosen from the group consisting of: Noryl SA90, hydroxyl-terminated silicone, catechol, tris (2-hydroxyethyl)isocyanurate), hydroxyl-terminated silicone nonylphenol, Bisphenol-A, and Bisphenol-A's dimer, trimer, and tetramer derivatives.

19. An insulation tape for a stator ground wall, the insulation tape comprising:
a mica tape; and
at least approximately 25% weight or less than approximately 12% of a resin binder incorporated into the mica tape, the resin binder comprising:
an epoxy or a combination of epoxies with desired performance, and
a polymer material, wherein the polymer material is hydroxyl-terminated.

20. The insulation tape of claim 19, wherein the mica tape comprises:
a mica paper layer of approximately 4 mil to approximately 7 mil, wherein the resin binder is incorporated into the mica paper layer, and
a glass backing layer of approximately 1 mil to approximately 3 mil.

21. The insulation tape of claim 19, wherein the insulation tape is wound around a plurality of stator bars and cured.

22. The insulation tape of claim 21, wherein the resin binder is applied to the tape following winding of the insulation tape around the plurality of stator bars, and wherein if the resin binder is at least approximately 25%, the curing includes an autoclave technique, and wherein if the resin binder is less than approximately 12%, the curing includes a vacuum pressure impregnation technique.

23. The insulation tape of claim 22, wherein a curing profile for an autoclave process for the resin binder includes a vacuum cycle of 80° C. to 140° C. for 8-12 hours followed by a curing cycle at 160° C. to 175° C. or higher for 10 to 20 hours.

24. The insulation tape of claim 20, wherein the plurality of stator bars comprises a plurality of stator coils which are inserted into a stator core.
